(19) United States
(12) Patent Application Publication
(10) Pub. No.: US 2011/0102371 A1
(43) Pub. Date: May 5, 2011

(54) Optical Touch Panel

(76) Inventors: Hsun-Wen Chang, Taipei City (TW); Yeh-Fang Duann, Taipei (TW)

(21) Appl. No.: 12/611,263

(22) Filed: Nov. 3, 2009

(51) Int. Cl. G06F 3/042

(52) U.S. Cl. 345/175

(57) ABSTRACT

Disclosed herein is an optical touch panel, which includes a display panel, at least one emitting member and at least one detector. The emitting member includes a reflector, a prism sheet and a light source. The emitting member is arranged along and above a portion of the peripheral of the display panel. The prism sheet has a plurality of prisms thereon, and is capable of directing the light emitted from the light source toward and across the display area. The detector is operable to receive and detect the light emitted from the emitting member. While an object appears on the display area, a position of the object may be determined by processing the light signal detected by the detector.

### BACKGROUND

1. Field of Invention

The present disclosure generally relates to an optical detecting device. More particularly, the present invention relates to an optical touch panel.

2. Description of Related Art

Recently, the demand for touch panels is dramatically increasing since the touch or pen-based input technologies are wildly employed in electronic devices such as personal digital assistant (PDA), mobile phone, computer and laptops. In general, touch panels are installed on display devices connected to computers for enabling a person to press thereon with a finger or a pen to input instructions or data.

One conventional approach to providing a touch or pen-based input system is to overlay a resistive or capacitive film over the display screen. This approach has a number of disadvantages. For example, the film decreases the overall brightness of the display device and causes the display to appear dim.

Another approach to providing touch or pen based input system is to use an array of source LEDs along two adjacent X-Y sides of an input display and a reciprocal array of corresponding photodiodes along the opposite two adjacent X-Y sides of the input display. However, this type of touch panel needs a large number of LEDs and photodiodes to achieve a desirable resolution for a typical data input display.

Yet another approach involves a plurality of photosensitive thin film transistor disposed on a LCD panel. These photosensitive thin film transistors would produce photo current while being illuminated by the ambient light. When the photosensitive thin film transistor is shielded by a touch object, the photo current produced by the thin film transistor would decrease. In this way, the position of the touch object may be determined. But this technology still suffers a decrease in brightness due to the arrangement of photosensitive thin film transistors on the LCD panel.

The above mentioned systems have drawbacks in either having a complex structure or a decrease of the brightness. Accordingly, there exists in this art a need of an improved touch panel that may overcome the above mentioned problems.

### SUMMARY

The present disclosure provides an optical touch panel, which includes a display panel having a display area, at least one emitting member, and at least one detector.

The emitting member is arranged along and above a portion of the peripheral of the display panel, and capable of emitting a light toward and across the display area. The emitting member includes a reflector, a prism sheet and a light source. The reflector is arranged along and above a portion of the peripheral of the display panel, wherein the reflector has a recess extending along a lengthwise direction of the reflector and the recess substantially faces the display area. The prism sheet is disposed above the recess of the reflector to form a cavity. Furthermore, the prism sheet has a plurality of prisms disposed on a side of the prism sheet near the display area, and each of the prisms has a ridge extending along the lengthwise direction of the reflector. The light source is operable to emit a light into the cavity.

The detector is disposed in the vicinity of a corner of the display panel. The detector is capable of receiving and detecting the light emitted from the emitting member. When an object appears on the display area, the position of the object may be determined by processing the light signal detected by the detector.

According to one embodiment of the present disclosure, each of the prisms has a substantially isosceles triangular cross-section. In one example, each of the prisms has an apical angle of about 20° to about 90°, more specifically, about 50° to about 70°.

According to another embodiment of the present disclosure, the prisms are made from a material having a refractive index in the range of about 1.35 to about 1.65. For instance, the prism may be made from a material such as acrylic resin, polyester, polyethylene terephtalate, and Poly(methyl methacrylate).

According to still another embodiment of the present disclosure, the reflector may further include a plurality of bumps disposed on a surface of the recess.

It is to be understood that both the foregoing general description and the following detailed description are by examples, and are intended to provide further explanation of the invention as claimed.

### BRIEF DESCRIPTION OF THE DRAWINGS

The invention can be more fully understood by reading the following detailed description of the embodiment, with reference made to the accompanying drawings as follows:

FIG. 1 is a schematic top view of an optical touch panel 100 according to one embodiment of the present disclosure;

FIG. 2 is a cross-section view taken along line II-II of FIG. 1;

FIG. 3 is a schematically perspective decomposition chart of an emitting member according to one embodiment of the present disclosure;

FIG. 4 is a cross-section view of a prism sheet according to one embodiment of the present disclosure;

FIG. 5 is a cross-sectional view of prism sheet according to another embodiment of the present disclosure;

FIG. 6 is a schematic top view of an emitting member according to one embodiment of the present disclosure; and

FIG. 7 is a schematic top view of an emitting member according to another embodiment of the present disclosure.

### DETAILED DESCRIPTION

In the following detailed description, for purposes of explanation, numerous specific details are set forth in order to provide a thorough understanding of the disclosed embodiments. It will be apparent, however, that one or more embodiments may be practiced without these specific details. In other instances, well-known structures and devices are schematically shown in order to simplify the drawings.

Reference will now be made in detail to the present embodiments of the invention, examples of which are illustrated in the accompanying drawings. Wherever possible, the same reference numbers are used in the drawings and the description to refer to the same or like parts.

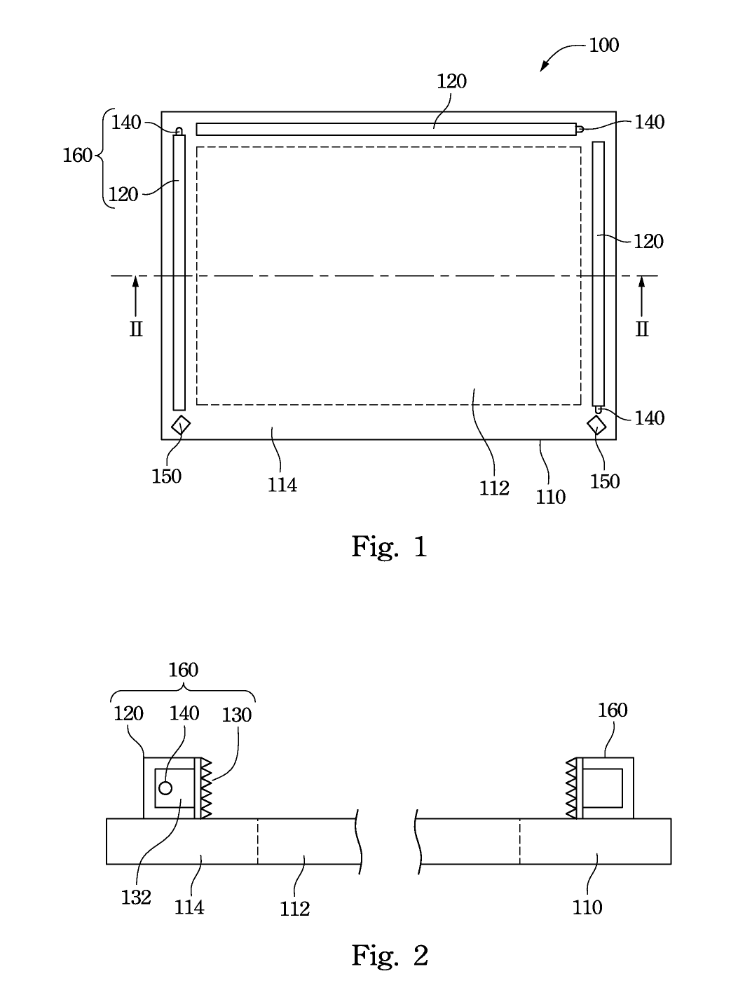

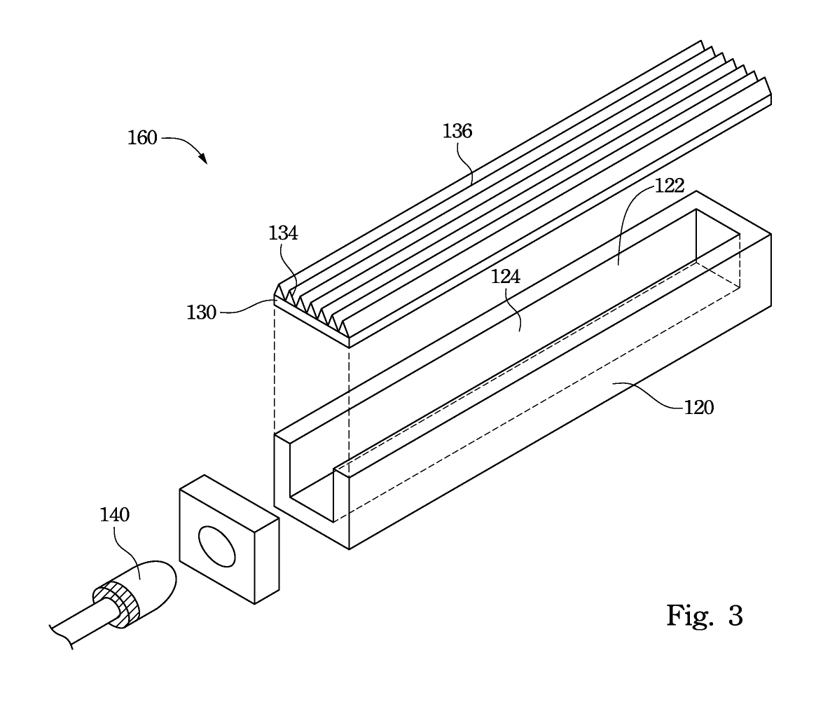

Referring to FIG. 1, which is a schematic top view of an optical touch panel 100 according to one embodiment of the present disclosure. FIG. 2 is a cross-sectional view taken along line II-II of FIG. 1. The optical touch panel 100 includes a display panel 110, at least one emitting member 160, and at least one detector 150.

The display panel 110 may be any kind of display devices such as LCDs, PDPs, OLEDs, etc. The display panel 110 has a display area 112 surrounded by the peripheral 114 of the display panel 110, as shown in FIG. 1.

In one embodiment, the optical touch panel 100 may have three emitting members 160. Each of the emitting members 160 is arranged along and above a portion of the peripheral 114 of the display panel 110. One of the three emitting members 160 is disposed at the upper side of the display panel 110, while another two emitting members 160 are disposed respectively at the left and right side of the display panel 110. The length of each of the emitting member 160 is substantially equal to the length of the corresponding side of the display area 112. Each of the emitting members 160 is capable of emitting a light toward and across the display area 112 of the display panel 110. The emitting member 160 includes a reflector 120, a prism sheet 130, and a light source 140, as shown in FIG. 2.

FIG. 3 is a schematic diagram of the emitting member 160 according to one embodiment of the present disclosure. The reflector 120, which constitutes the main body of the emitting member 160, is arranged along and above a portion of the peripheral 114 of the display panel 110. The reflector 120 has a recess 122 that extends along a lengthwise direction of the reflector 120. While the reflector 120 is disposed on the peripheral 114 of the display panel 110, the reflector 120 is positioned in such a way that the recess 122 substantially faces the display area 112. In one embodiment, the reflector 120 has a substantially U-shaped cross-section, as illustrated in FIG. 2 and FIG. 3.

There is no specific limitation on the material of the reflector 120 so long as the surface of the recess 122 can provide reflective function to a light emitted from the light source 140. For example, reflector 120 may be made of a white plastic material and thus has a white surface. Alternatively, the reflector 120 may be coated with a reflecting layer 124 on the surface of the recess 122, and the reflecting layer 124, may be a layer made of silver (Ag), aluminum (Al) or chromium (Cr).

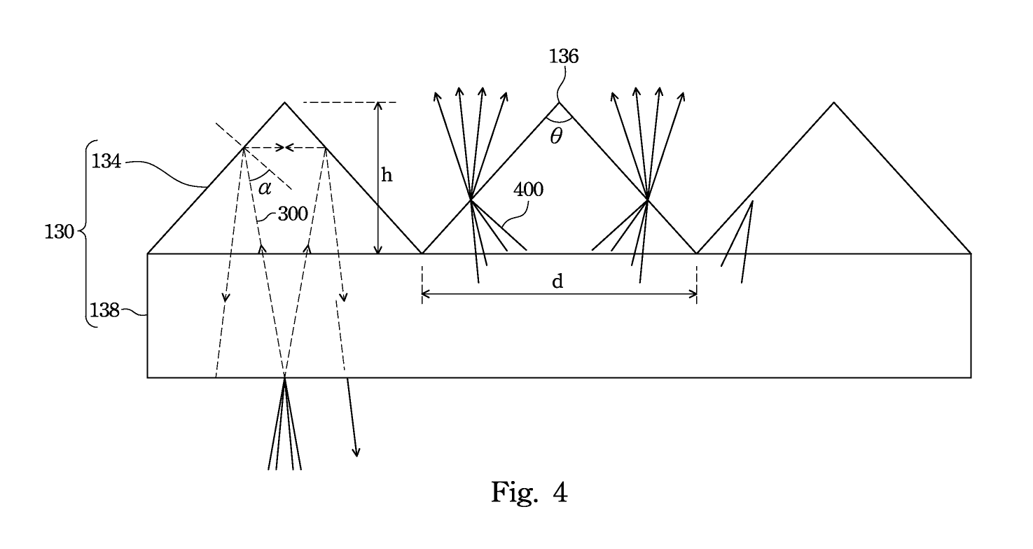

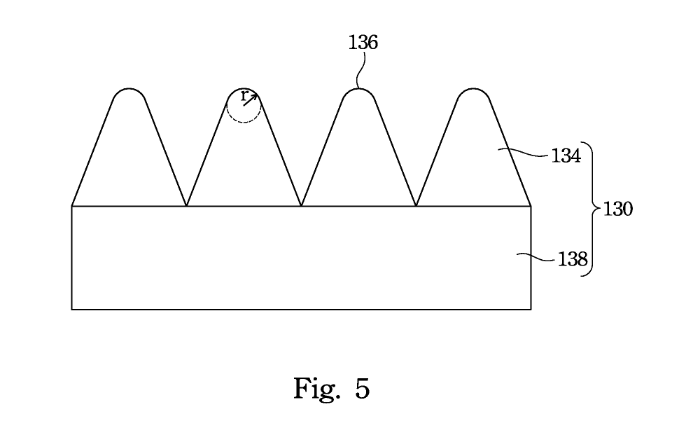

The prism sheet 130 is disposed above the recess 122 of the reflector 120 and thereby forms a cavity 132, which is surrounded by the reflector 120 and the prism sheet 130. Moreover, the prism sheet 130 has a plurality of prisms 134 disposed on a side of the prism sheet 130 near the display area 112. Each of the prisms 134 has a ridge 136 which extends along the lengthwise direction of the reflector 120. FIG. 4 shows a cross-section view of a prism sheet 130 according to one embodiment of the present disclosure. In one example, each of the prisms 134 has a substantially isosceles triangular cross-section. The apical angle θ of each of the prisms 134 may be in the range of about 20° to about 160°, more specifically, about 20° to about 90°. In another example, the apical angle θ of each of the prisms 134 is in the range of about 50° to about 70°, for example, 60°. In still another example, each of the prisms 134 may have a height h of about 10 μm to about 100 μm, and may have a bottom width d in the range of about 10 μm to about 100 μm. FIG. 5 is a cross-sectional view of prism sheet 130 according to another embodiment of the present disclosure. In this embodiment, each of the prisms 134 may have a blunt ridge 136. For instance, the cross-section of each of ridge 136 may have a radius of curvature r, which may be in the range of about 3 μm to about 15 μm.

In one embodiment, the prism sheet 130 includes a base film 138 and a plurality of prisms 134 disposed on the base film 138. In one example, the prisms 134 are made from a material having a refractive index in the range of about 1.35 to about 1.65. The material of the base film 138 may be the same as or different from the prisms 134. The prisms 134 and/or the base film 138 may be made from a material such as acrylic resin, polyester, polyethylene terephtalate, and Poly(methyl methacrylate).

The light source 140 is operable to emit a light into the cavity 132. In one embodiment, the light source 140 may be disposed at one end of the reflector 120, and thereby the light emitted from the light source 140 may be directed into the cavity 132. One portion of the light that are directed into the cavity 132 may be reflected by the surface of the recess 122 and by the surface of the prism sheet 130, whereas another portion of the light, such as the portion that is projecting to the prism sheet 130, may be transmitted out of the prism sheet 130. Whether the light in the cavity 132 is being reflected or being transmitted depends on the incident angle of the light, and the details are described in the following paragraph. As such, the light emitted from the light source 140 may be guided toward the display area 112 of the display panel 110. In one example, the light source 140 may be a light emitting diode (LED). In another example, the light source 140 is operable to emit an infrared (IR) light or a visible light.

Referring back to FIG. 4, which schematically illustrates the optical path in the prism sheet 130. The light (indicated as number 300) projecting to the interface between the prisms 134 and the air with a larger incident angle α would be reflected back to the cavity 132 due to the total reflection phenomena of Snell's Law. However, the light (indicated as number 400) projecting to the interface between the prisms 134 and the air with a smaller incident angle may exist the prism sheet 130. In this way, the prisms 134 disposed on the prism sheet 130 may restrain the direction of the light that transmits through the prism sheet 130. Therefore, the major portion of the light transmitting through the prism sheet 130 may be controlled in a smaller divergent angle, and thus a light curtain may be formed above the display area 112 of the display panel 110.

Referring back to FIG. 1, at least one detector 150 is disposed in the vicinity of a corner of the display panel 110. In one example, the optical touch panel 100 has two detectors 150, and each of the two detectors 150 is positioned at a corner of the display panel 110. In another example, the two detectors 150 are respectively positioned at two adjacent corners of the display panel 110. In one embodiment, the detector 150 may include a COMS sensor.

Each of the emitting members 160 is capable of emitting a light toward and across the display area 112 of the display panel 110. The detector 150 may detect the light emitted from the emitting members 160. While an object such as a finger or a stylus pen appears on the display area 112 of the display panel 110, the light emitted from the emitting members 160 is shielded by the object and thereby changes the light entered and sensed by the two detectors 150. By processing the light signals detected by the two detectors 150, the position of the object may be determined, which is known in the art.

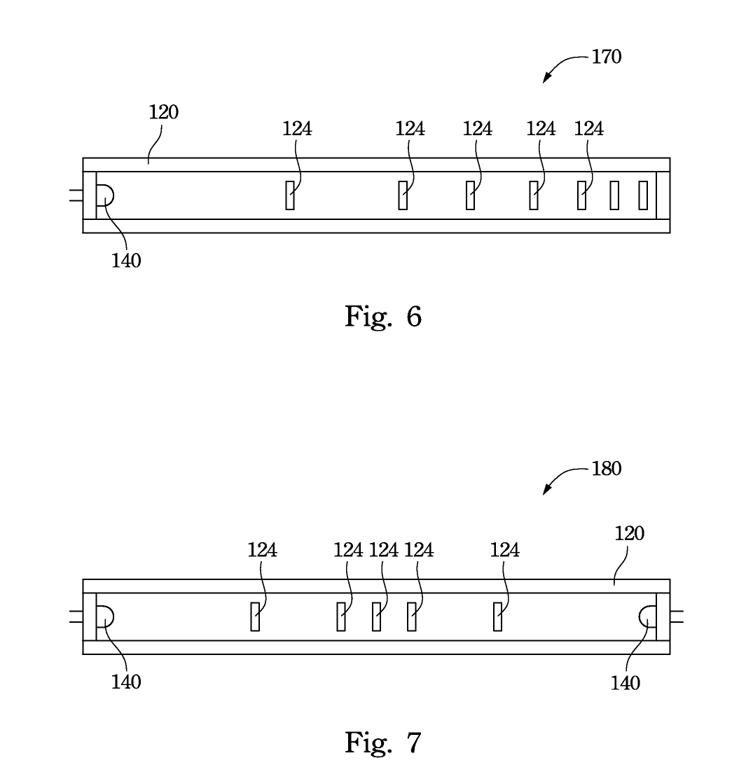

FIG. 6 is a schematic top view of an emitting member 170 according to one embodiment of the present disclosure. The emitting member 170 includes a reflector 120, a light source 140 positioned at one end of the reflector 120, and a prism sheet (not shown in FIG. 6). In this embodiment, the reflector 120 has a plurality of bumps 124 disposed on the surface of the recess 122. The bumps 124 may locally increase the light exiting out of the emitting member 170, and thus compensates the light intensity at the end of the reflector 120, which is far from the light source 140. For example, the end of the reflector 120 far from the light source 140 may have a higher bump density (i.e. the number of bumps per unit length of the reflector) than the other end. The geometrical contour of the bumps 124 is non-limited. For example, the bumps 124 may have a strip shape, a circle shape or others.

FIG. 7 is a schematic top view of an emitting member 180 according to one embodiment of the present disclosure. The emitting member 180 includes a reflector 120, two light sources 140, and a prism sheet (not shown in FIG. 7). In this embodiment, each of the light sources 140 is positioned at the end of the reflector 120. The reflector 120 has a plurality of bumps 124 disposed in the vicinity of the center portion of the reflector 120 to compensate the light emitting out from the center portion of the emitting member.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims.

What is claimed is:

1. An optical touch panel, comprising:
a display panel having a display area;
at least one emitting member arranged along and above a portion of the peripheral of the display panel, the emitting member comprising:
a reflector arranged along and above a portion of the peripheral of the display panel, wherein the reflector has a recess extending along a lengthwise direction of the reflector and wherein the recess substantially faces the display area;
a prism sheet disposed above the recess of the reflector to form a cavity, wherein the prism sheet has a plurality of prisms disposed on one side of the prism sheet near the display area, and each of the prisms has a ridge extending along the lengthwise direction of the reflector; and
a light source for emitting a light into the cavity; and
at least one detector disposed in the vicinity of a corner of the display panel.

2. The optical touch panel of claim 1, wherein each of the prisms has a substantially isosceles triangular cross-section.

3. The optical touch panel of claim 2, wherein each of the prisms has an apical angle of about 20° to about 90°.

4. The optical touch panel of claim 3, wherein the apical angle of each of the prisms is in the range of about 50° to about 70°.

5. The optical touch panel of claim 2, wherein each of the prisms has a bottom width of about 10 μm to about 100 μm.

6. The optical touch panel of claim 2, wherein each of the prisms has a height of about 10 μm to about 100 μm.

7. The optical touch panel of claim 1, wherein the ridge of each of the prisms has a radius of curvature in the range of about 3 μm to about 15 μm.

8. The optical touch panel of claim 1, wherein the prisms are made from a material having a refractive index in the range of about 1.35 to about 1.65.

9. The optical touch panel of claim 1, wherein the prism sheet comprises at least one material selected from the group consisting of acrylic resin, polyester, polyethylene terephtalate, and Poly(methyl methacrylate).

10. The optical touch panel of claim 1, wherein each of the prisms comprises at least one material selected from the group consisting of acrylic resin, polyester, polyethylene terephtalate, and Poly(methyl methacrylate).

11. The optical touch panel of claim 1, wherein the reflector has a substantially U-shaped cross-section.

12. The optical touch panel of claim 1, wherein the reflector has a white surface.

13. The optical touch panel of claim 1, wherein the reflector further comprises a reflecting layer disposed on a surface of the recess, and the reflecting layer comprises at least one material selected form the group consisting of Ag, Al, and Cr.

14. The optical touch panel of claim 1, wherein the reflector further comprises a plurality of bumps disposed on a surface of the recess.

15. The optical touch panel of claim 1, wherein the light source is operable to emit an infrared light.

16. The optical touch panel of claim 1, wherein the light source comprises a light emitting diode.

17. The optical touch panel of claim 1, wherein the light source is disposed at one end of the reflector.

18. The optical touch panel of claim 1, wherein the detector comprises a CMOS sensor.
